(19) United States
(12) Patent Application Publication
(10) Pub. No.: US 2007/0013533 A1
(43) Pub. Date: Jan. 18, 2007

(54) "P" alert

(76) Inventors: John P. Zazzara SR., So. Plainfield, NJ (US); James J. Denker, Monmouth Beach, NJ (US)

Correspondence Address: JOHN P. ZAZZARA SR., 203 OAK MANOR PKWY, SO. PLAINFIELD, NJ, 07080, US

(21) Appl. No.: 11/178,532

(22) Filed: Jul. 12, 2005

(51) Int. Cl. G08B 21/00

(52) U.S. Cl. 340/604

(57) ABSTRACT

The invention relates to a sensor unit for detecting the wetting of a diaper. Signals from the condensation sensor are used to control an audible alarm and/or musical chime unit. The signals of the moisture sensor, on the contrary, are used to control the ground connection of a musical chip. A sensor unit, which comprises two contacts, mounted on a circular housing base is placed on the interior of the diaper. In a preferred variant, both contacts are coupled to a common switchable evaluation unit, which utilizes the conductivity of moisture to complete a ground to the musical alarm. In an improvement of the invention, both contacts are integrated into a plastic waterproof sensor module.

### BACKGROUND OF THE INVENTION

1. Field of the Invention

The present invention relates to a sensor unit for detecting the wetting of a diaper, applicable to cloth as well as disposable diapers.

2. Description of the Background Art

Condensation sensors to detect internal moisture and water sensors to detect wetting of the diaper surface are known in the conventional art. In this case, signals from the condensation sensor are used to control an audible alarm and/or musical chime unit. The signals of the water sensor, on the contrary, are used to control a musical chime unit. Sensors of this type operate, internally, according to the optoelectronic, resistive, or capacitive principle.

A device for the automatic control of a musical chime unit, comprises a moisture sensor and an evaluation unit.

Disclosed is a method for the manufacture of a moisture sensor working by the direct capacitive measuring principle, said sensor which has at least two electrically conductive, adjacent sensor elements, form an capacitor of variable capacitance, while working together with the electrically conductive substances wetting the sensor field, preferably water. The sensor consists substantially of two surface contacts, which are placed on a cloth diaper and form the capacitive element.

### SUMMARY OF THE INVENTION

It is therefore an object of the present invention to provide a sensor unit, which detects internal wetting, and which is reduces prolonged exposure to rash producing moisture.

The invention is based on the idea of equipping the sensor unit with at least two sensor contacts, both of which are placed on the interior of the diaper. In an embodiment of the invention, both sensor contacts are coupled to a common switchable evaluation unit, so that evaluation of the sensors both incipient condensation or incipient wetting on the interior of a diaper is detected.

In a preferred improvement of the invention, both sensor contacts are integrated into a small-scale sensor module. The detection not desired in each case has no effect on the evaluation of the desired detection. In addition, measures can also be provided, for example, a capacitive shielding, by which the undesired effect is also prevented.

The sensor contacts and evaluation unit form the sensor unit and are integrated into the module.

The moisture sensor is formed by a capacitative electrode structure in a nondifferential arrangement of the sensor surfaces.

In a further embodiment, a compact sensor module is provided through further integration of the sensor together with the common switchable unit. Other sensors, such as a driving light sensor, sun sensor, etc., can be easily integrated into this module.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a sensor module top elevation;

FIG. 2 is a side elevation of the sensor unit of FIG. 1; with a cutout showing activating contacts.

FIG. 3 is a general structure of a sensor module; and

FIG. 4 is the bottom view of the sensor evaluation unit.

FIG. 5 is the bottom view of the sensor unit assembly outer cover.

FIG. 6 side elevation of sensor unit assembly

FIG. 7 top elevation of complete sensor unit assembly; with handling strap

FIG. 8 is a schematic of the sensor unit internal connections

### DETAILED DESCRIPTION OF THE PREFERRED EMBODIMENTS

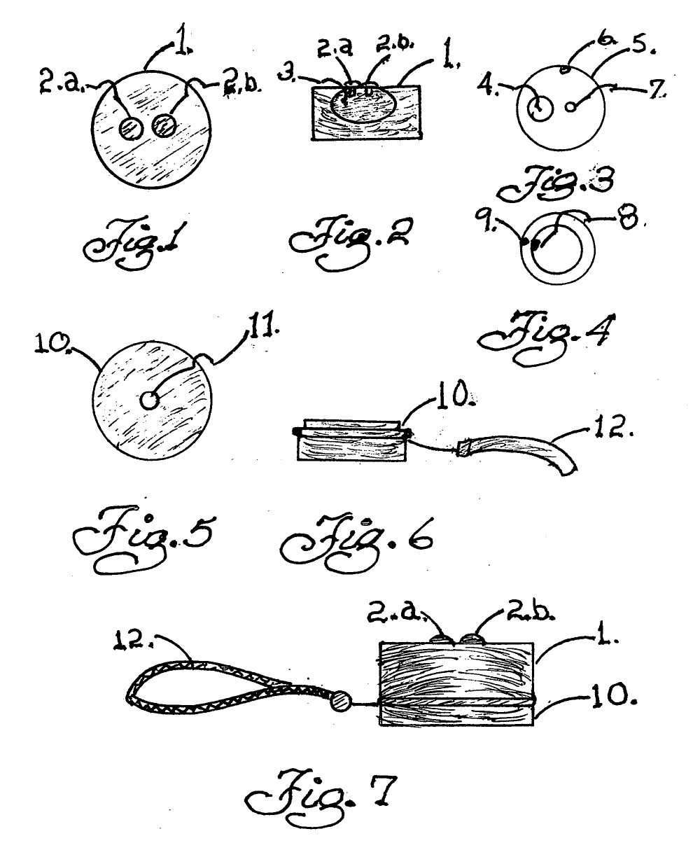

FIGS. 1 thru 3 show a general sensor unit, which comprises two separate sensor contacts 2a and 2b, and a moister sensor 5. Both sensor contacts, are electrically connected to the HN402 evaluation/alarm unit. The specific supply 4 or signal lines 6 and 7 are preferably integrated into a single structure.

FIG. 3 shows the audio output speaker mounting post 8 and 9.

The condensation sensor 5 works on a capacitive basis, whereby the capacitance of the condenser is changed by the moisture uptake of a polymer structure (not described) of the condensation sensor 5.

The sensor surface of the moisture sensor 5 includes two electrically separated conductive tracks 2a, 2b (see FIG. 4). The capacitance of the rain sensor 2 is changed by the effect of the stray fields of these two conductive tracks 21, 22, working as condenser electrodes, e.g., by moisture.

By switching the input of the evaluation unit 5, the specific signal of the sensor 5 is sent for evaluation, which is evaluated according to the programming.

The switching of the sensor 5, is not time-critical, because the reaction to the sensor signal can be long, compared with the switching and evaluation time.

FIG. 5 shows the musical speaker assembly 11 and outer housing 10.

The moisture sensor 5, FIG. 3, are placed on the inside of a plastic housing 10 shown in FIG. 6.

FIG. 7 shows as an advantageous design of a sensor module, which comprises a moisture sensor housing 10, the signals of which are taken for evaluation via a common switchable evaluation unit, whereby in the preferred variant the entire evaluation unit is a component of the sensor module. The rubber handling strap 12 is also shown in this figure.

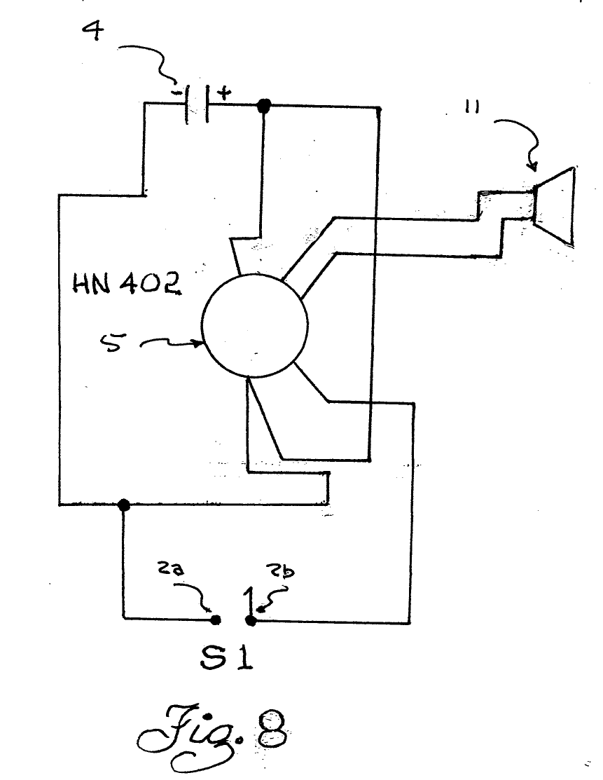

The sensor module comprises a common supporting component connected as shown in FIG. 8, on which the moisture sensor 5, contacts 2a and 2b, power source 4 and mini-speaker 11 are placed together.

1. A sensor unit for detecting the wetting of a diaper, comprising:
a sensor for detecting internal wetting, the sensor being located on the interior of the diaper.

2. The sensor unit according to claim 1, wherein said sensor contacts are electrically connected to a common switchable evaluation unit, and wherein the sensor signal is connected to the evaluation unit whose signal is to be evaluated by the evaluation unit.

3. The sensor unit according to claim 1, wherein the sensor unit is constructed as a plastic sensor module with metallic contacts.

4. The sensor unit according to claim 3, wherein said first and second sensor contacts are placed together on a supporting component of the sensor module.

5. The sensor unit according to claim 3, wherein components of at the evaluation unit are located on a supporting component of the sensor module.

6. The sensor unit according to claim 1, wherein the internal wetting of the sensor is detected by the direct capacitative measuring principle.

7. The sensor unit according to claim 6, wherein the sensor has a capacitative electrode structure in a nondifferential arrangement of the sensor surfaces.

8. The sensor unit according to claim 1, wherein the sensor is a moisture sensor.

9. A method for detecting interior diaper moisture, said method comprising the following steps:
detecting interior wetting of the diaper by sensor contacts positioned on an interior surface of the diaper;
whereby an evaluation unit receives signals from said sensor contacts, makes an evaluation and outputs a ground signal to the musical alarm chip, dependent on the evaluation.
